(19) United States
(12) Patent Application Publication
(10) Pub. No.: US 2006/0095585 A1
(43) Pub. Date: May 4, 2006

(54) System and method for establishing communication between a client and a server in a heterogenous ip network

(75) Inventors: Franciscus A. C. Meijs, Helmond (NL); Mariana V. Nikolova, Eindhoven (NL); Marc Vauclair, Overjse (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/540,186

(22) PCT Filed: Dec. 5, 2003
(86) PCT No.: PCT/IB03/05733

§ 371 Date: Jun. 20, 2005

(30) Foreign Application Priority Data
Dec. 20, 2002 (US) 60435236

(51) Int. Cl. G06F 15/16

(52) U.S. Cl. 709/245

(57) ABSTRACT

A method and system allow a client (e.g. 14, 34, 36) to communicate with a server (e.g. 19, 20, 22, 26, 30) whose hostname is not resolvable via a DNS server in a heterogeneous IPv6/IPv4 network (e.g. 300). Resolution is achieved by providing the client with two tables (40, 50), preferably stored at a portal (18) in the network (300), whereby the client performs a protocol exchange with the portal (18) using the table information to enable a communication with the server (19, 20, 22, 26, 30).

The present invention generally relates to electronic content delivery between a client and a server in a heterogeneous IP network. In particular, the invention relates to a method for allowing a client, in a heterogeneous network, to communicate with a server whose hostname is not resolvable via a DNS server.

The Internet Protocol (“IP”) is an addressing protocol designed to facilitate the routing of traffic within a network or between networks. In the last years the Internet Protocol is being used on many computer networks including the Internet and intranets. The current version of the Internet Protocol, namely version 4 (“IPv4”) supports a limited address space. With a 32-bit address-field, it is possible to assign up to 2³² different IPv4 addresses, which is 4 294 967 296, or greater than 4 billion globally unique addresses. Internet Protocol version 6 (“IPv6”) proposes the use of a 128-bit address-field for IP addresses. IPv6 also includes some additional architectural improvements over the existing IPv4 protocol, such as address auto-configuration, neighbor discovery, and router discovery. Despite the advantages afforded by IPv6, a large number of networks (including a large number of Internet subnets) will still be using the IPv4 for many years to come. This is due to the massive financial and knowledge investments already done in the existing Internet infrastructure. Therefore, the transition to IPv6 will require an extended period of time during which IPv6 will initially coexist with and then gradually begin to supplant the existing IPv4 protocol.

For these reasons, an interim heterogeneous IPv6/IPv4 infrastructure is anticipated in which IPv6/IPv4 entities appear. The latter support both IPv6 and IPv4 in their network protocol stacks and can communicate via both protocols. Current efforts to support IPv4 and IPv6 coexistence focus on inter-domain routing between “IPv6 islands” (or sub-nets) that use the existing IPv4 backbone as a transit. However, these islands themselves may have a complex heterogeneous IPv4 and IPv6 internal structure (e.g., large academic or commercial campus “intranets”) that require intra-domain IPv4 to IPv6 transition mechanisms and strategies as well.

In short, translators and tunneling are the well-known transition mechanisms. The former is not considered further in this application. Tunneling is well known in the art and operates by creating point-to-point tunnels whereby IPv6 packets are encapsulated within IPv4 headers to carry them over IPv4 routing infrastructure. Two types of tunneling techniques are disclosed in RFC 2893—configured and automatic. Configured tunneling is characterized by a manual configuration of the tunnel endpoint address on the encapsulating node. The configured tunneling is expensive in terms of configuration and operational administrative resources, and does not adapt to network topology changes. Automatic tunneling is characterized by an automatic configuration of the tunnel endpoint address on the encapsulating node, i.e. it does not need any manual configuration and moreover it adapts to network topology changes. That is why the automatic tunneling is preferable. Automatic tunneling is possible due to use of special IPv6 addresses with embedded IPv4 addresses. The latter are used by the encapsulating node to define the end-points of the tunnel. The types of IPv6 addresses facilitating automatic tunneling are listed below:
IPv4-compatible IPv6 address (ref. RFC 1886)
IPv4-mapped IPv6 addresses (ref. RFC 1886);
6 over 4 addresses (ref. RFC 2529);
6 to 4 addresses (ref. RFC 3056);
ISATAP addresses (ref. RFC draft-ietf-ngtrans-isatap-06.txt);
   6 to 4 addresses, as defined in RFC 3056, are used in those cases where inter-sites automatic tunneling (between different sub-nets) is performed. The low-order 80-bits of a 6 to 4 address contains information locally available to an IPv6 node such as a Site-Level Aggregation Identifier (SLA ID) and an Interface ID. The latter usually equals to the MAC address of the IPv6 node that is built in when manufactured. The high-order 48-bits are known as a 6 to 4 prefix. The IANA has permanently assigned the numeric value 0×0002, i.e. 2002::/16, to the high-order 16-bits of the 6 to 4 prefix. The low-order 32-bits of the 6 to 4 prefix are reserved for colon-hexadecimal representation of the globally unique IPv4 address of the subscriber site. An example of 6 to 4 prefix is 2002:8291:ae7c::/48 corresponding to the public IPv4 address 130.145.174.124.

When a client wants to contact a server (in either an IPv4 or an IPv6 network), for the purpose of getting content (e.g. web pages) or being involved in a communication (Audio/Video conference, chatting, gaming), the client must first know the server's binary IP address. The client and the server can be located either in the same or in different networks. The client usually refers to the server (host, mailbox or another resource) by a server's hostname (ASCII string) such as servernamephilips.com or by an e-mail address such as “friend@philips.com” and not by its binary IP address. Nevertheless, the underlying IP network itself only understands IP address, so the mechanism known as a Domain Name System (DNS) is used to convert the ASCII strings to binary IP addresses. Initially DNS supported only IPv4 addresses, but later on it was extended to support IPv6 address aggregation and renumbering, (see RFC 2874). However, in the transition period from IPv4 to IPv6 the DNS infrastructure may not fully support IPv6, i.e. there are isolated DNS servers that do not maintain IPv6 records (i.e., AAAA or A6 records). Therefore, IPv6 nodes whose primary and secondary DNS servers do not support A6 records would not be reachable (addressable) by other IPv6 nodes by a hostname since the latter cannot be resolved in an IPv6 address.

Accordingly, the present invention proposes a new mechanism that overcomes the current limitation of not being able to address an IPv6 node by another IPv6 node in the case where the primary and secondary DNS servers servicing the IPv6 node being addressed do not support A6 records.

The present invention is directed to a method for allowing a client to communicate with a server whose hostname is not resolvable via a DNS server in a heterogeneous IPv6/IPv4 network.

According to an aspect of the present invention, a method for addressing a server in an IPv6 sub-net from a client includes the steps of: making a request, by a user associated with said client, to a portal in said network for a list of server node hostnames capable of providing a desired content to said client; providing a first table and a second table from said portal to said client responsive to said client request, said first table including said list of server node hostnames; filtering at said client, said provided list of server hostnames to exclude those server node hostnames with whom said client cannot establish a communication; selecting by said user, a server hostname from said filtered list of server node hostnames; determining from said first table if an IP address associated with said user selected server's hostname is resolvable via a domain name server (DNS); if said step (e) (WHICH IS THIS STEP? COPY & PASTE problem?) is satisfied, obtaining said associated IP address from said DNS; and if said step (e) is not satisfied, executing a protocol by said client with said portal to determine one or more default IP addresses of a server having said selected server's hostname.

According to an aspect of the invention, a system for addressing server in an IPv6 sub-net from a client includes: means for making a request, by a user associated with said client, to a portal in said network for a list of server hostnames capable of providing a desired content to said client; means for providing a first table and a second table from said portal to said client responsive to said client request, said first table including said list of server node hostnames; means for filtering at said client, said provided list of server hostnames to exclude those server hostnames with whom said client cannot establish a communication; means for selecting by said user, a server hostname from said filtered list of server hostnames; means for determining from said first table if an IP address associated with said user selected server's hostname is resolvable via a domain name server (DNS); means for obtaining said associated IP address from said DNS if said means for determining is satisfied; and means for executing a protocol by said client with said portal to determine one or more default IP addresses of a server having said selected server's hostname if said means for determining is not satisfied.

The methods and systems described herein may help the transition from Internet Protocol version4 (“IPv4”) networks to Internet Protocol version6 (“IPv6”) networks. However, the present invention is not limited to such an embodiment, and can be used with virtually any set of networks that require transition between X-bit and Y-bit network addresses and dual network utilization.

These and other advantages will become apparent to those skilled in the art upon reading the following detailed description in conjunction with the accompanying drawings.

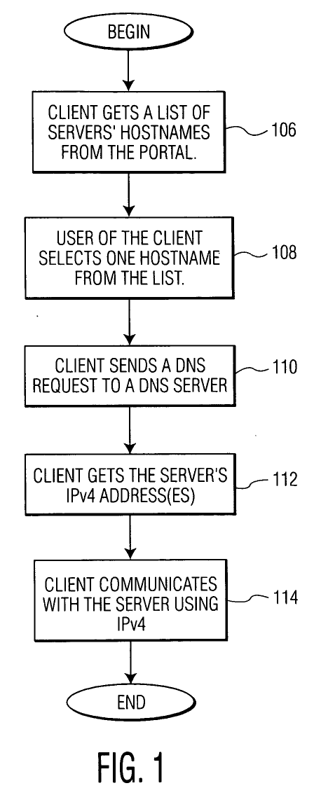

FIG. 1 is a flowchart illustrating the steps involved to allow a client access to a requested server in a homogeneous IPv4 network;

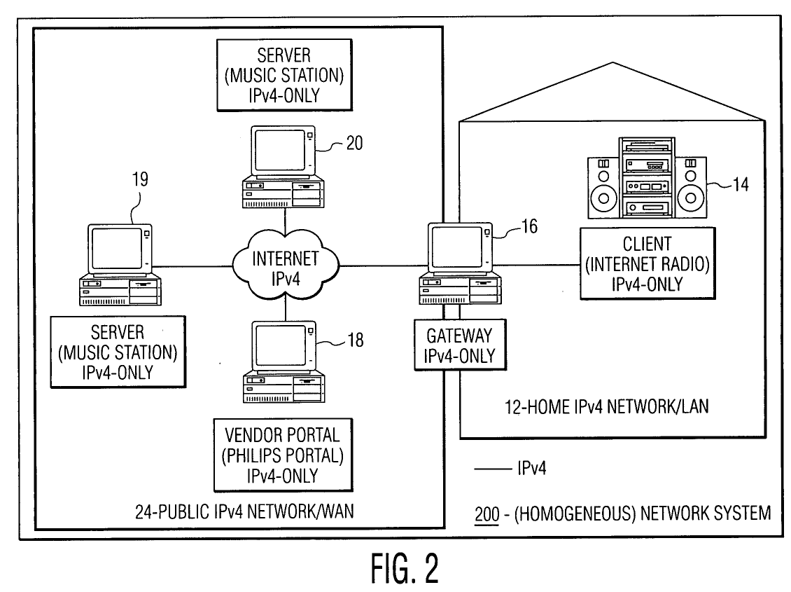

FIG. 2 is an illustration of a homogeneous IPv4 network in accordance with the prior art;

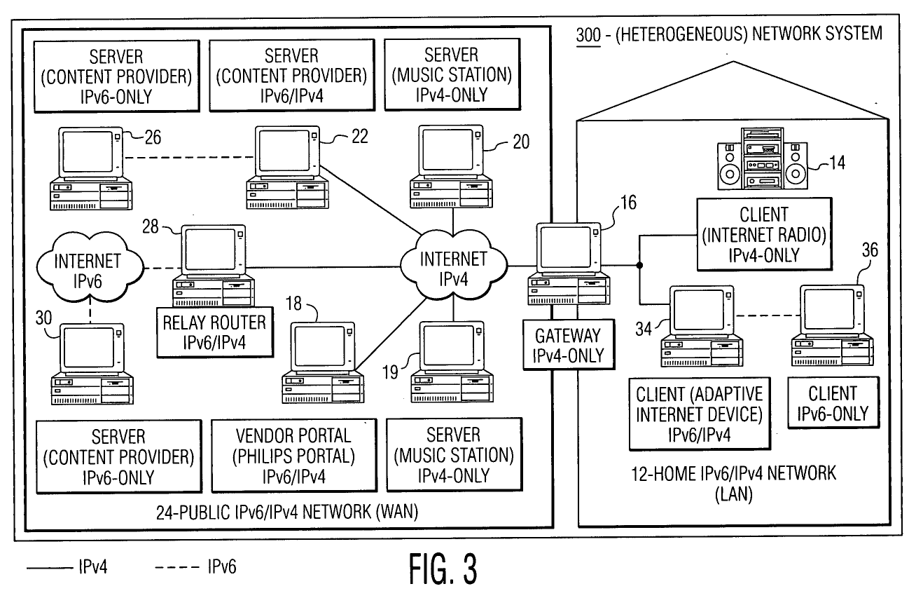

FIG. 3 is an illustration of a heterogeneous IPv6/IPv4 network in which the method of the invention may be practiced;

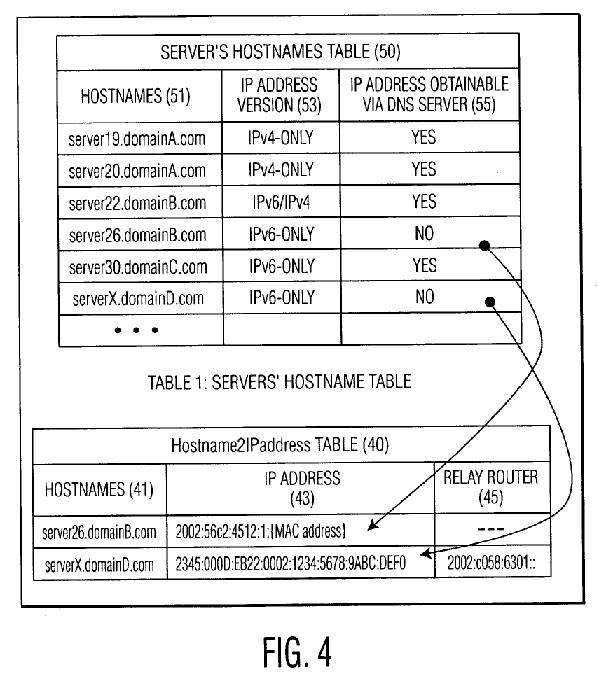

FIG. 4 is an exemplary structure of the Servers' hostname table and the Hostname2IPaddress table provided in the portal in the network of FIG. 2; and

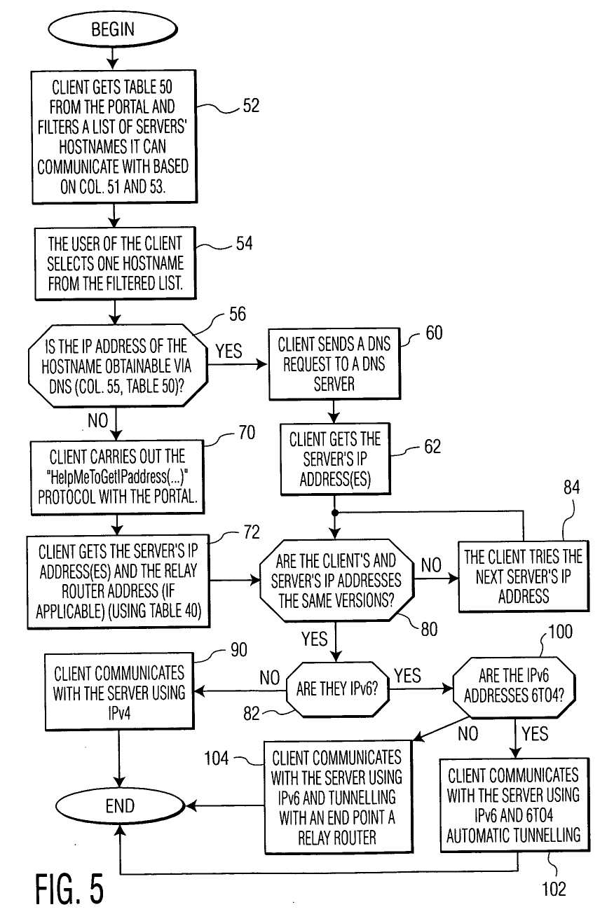

FIG. 5 is a flowchart illustrating the steps involved to allow a client access to a requested server in a heterogeneous IPv6/IPv4 network, where the server's IP address can or cannot be obtained by a DNS service.

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

A. Terminology

The following discussions will be made clearer by a brief review of the relevant terminology used throughout this application as given below.

A “node” is defined as a device that implements either IPv4 or IPv6 or both in its network protocol stack.

A “router” is defined as a node that forwards IP packets not explicitly addressed to itself.

A “gateway” is defined as a node that includes additional functionality as compared with a router such as NA(P)T, DHCP server, etc.

A “host” is defined as any node that is not a router or a gateway.

An “interface” is defined as a node's attachment to a link.

A “packet” is defined as an IP header plus any payload.

The term “IPv4-only node” generally refers to a host or a router that implements only IPv4 and does not understand IPv6.

The term “IPv6-only node” generally refers to a host or a router that implements only IPv6 and does not understand IPv4.

The term “IPv4/IPv6 node” generally refers to a host or a router that implements both IPv4 and IPv6.

The term “IPv4 node” generally refers to a host or a router that implements IPv4. IPv6/IPv4 and IPv4-only nodes are both IPv4 nodes.

The term “IPv6 node” generally refers to a host or a router that implements IPv6. IPv6/IPv4 and IPv6-only nodes are both IPv6 nodes.

The term “IPv4 packet” generally refers to an IPv4 header plus payload.

The term “IPv6 packet” generally refers to an IPv6 header plus payload.

An “IPv4 network” generally refers to a network consisting exclusively of IPv4 nodes.

An “IPv6 network” generally refers to a network consisting exclusively of IPv6 nodes.

An “IPv6/IPv4 network” generally refers to a network consisting of both IPv4 and IPv6 nodes.

B. Conventional IPv4 network

In order to better appreciate certain aspects of the present invention, it is instructive to first consider how a client accesses a server in a conventional IPv4 network.

FIG. 1 is a flowchart which generally describes how an IPv4-only client located in a first IPv4 network accesses an IPv4 server located in a second (different) IPv4 network via a DNS service. This process for gaining access to a server via a DNS service is well known in the art and is guaranteed to always resolve a host name to an IP address in a homogeneous network such as the exemplary IPv4 network of FIG. 2. However, the reliability of the DNS service is not guaranteed in every instance in a heterogeneous network, such as the IPv6/IPv4 network of FIG. 3, as will be described below. The present invention is directed to a method for allowing a client to gain access to a server in those instances where the DNS service cannot be relied upon in a heterogeneous network, as will be described below.

Referring now to the flowchart of FIG. 1, at step 106, a client upon making a request to a portal in the network for servers capable of providing a certain content type, e.g., audio, video, etc., is returned a list of applicable server hostnames from the portal. At step 108, a user of the client selects one server hostname from the provided list. At step 110, the client sends a DNS request to a default DNS server in the network. At step 112, the client is returned the server's IPv4 address(es). At step 114, the client communicates with the server using IPv4.

The principle of accessing a server from a client in a homogeneous network, as described in the flowchart of FIG. 1, is now reinforced by way of example. More particularly, FIG. 2 is a homogeneous network communication system 200 comprised of a public Wide Area Network (“WAN”) 24 and an office/home Local Area Network (“LAN”) 12. Both networks 12 and 24 are IPv4 based in that each of the client 14, gateway 16, vendor portal 18, server 19 and server 20 all support a common protocol, i.e., the IPv4 protocol (see RFC 791). In the exemplary network, client 14 is assumed to be an Internet radio client capable of receiving audio content from a plurality of Internet music stations (content providers) such as servers 19 and 20. To obtain audio content at the client 14, the client 14 must get a list of server hostnames that are able to provide the desired content (e.g., servers 19 and 20). To obtain the list of server hostnames, the client 14 first connects to a default portal in the network, e.g. vendor portal 18. It is assumed that the servers included in this list have registered themselves at the portal 18 in advance. Upon receiving the list a user associated with client 14 may then select one of the server's hostnames from the provided list. Then, to map the selected server's hostname to a binary IP address, the client 14 uses its default DNS server (not shown) in the network 10, as is conventional. The DNS server can be located either in the home network 12 or in the public network 24 (including on the vendor portal 18). Using the IPv4 address returned from the DNS server, the client 14 is then able to take up communication with the selected server, e.g. server 20, to receive the audio content.

The example above gets more complex as the homogeneous IPv4 based network 10 of FIG. 2 migrates from IPv4 to IPv6.

C. IPv4 to IPv6 Migration

The communication network system 300 of FIG. 3 represents an exemplary heterogeneous IPv6/IPv4 network for illustrating the principles of the invention. The network 300 represents, by example, one way in which the IPv4 based network 10 of FIG. 2 could migrate to a heterogeneous IPv6/IPv4 network. Home IPv4 network 12 of FIG. 2 has been expanded to include new clients—IPv6/IPv4 client 34 and IPv6-only client 36. Public IPv4 network 24 of FIG. 2 has been expanded to include an IPv6/IPv4 content provider 22 (typically a 6 to 4 router, see RFC 3056), an IPv6-only content provider 26 (typically a 6 to 4 host, see RFC 3056), an IPv6-only content provider 30 (having a native IPv6 address) and an IPv6/IPv4 relay router 28. The IPv6/IPv4 relay router 28 is configured to support routing between 6 to 4 addresses and native IPv6 addresses of IPv6-only servers.

For ease of explanation, it is assumed that the heterogeneous IPv6/IPv4 network 300 of FIG. 3 does not support translators but only tunneling as a transition mechanism. Therefore, communications between IPv4-only and IPv6-only hosts are not maintained (e.g., IPv4-only client 14 cannot communicate with IPv6-only server 30). All possible communications in network 300 are summarized in Table (I) below by indicating for a given client (col. 1), having an associated IP version (col. 2), which servers (col. 3), having an associated IP version (col 4), the client can communicate with directly or by means of tunnels.

TABLE I

| | | Server | |
|---|---|---|---|
| | Client IP | Communications | Server IP |
| Client | version | supported | version |
| 14 | IPv4-only | 19 | IPv4-only |
| | | 20 | IPv4-only |
| | | 22 | IPv6/IPv4 |
| 34 | IPv6/IPv4 | 19 | IPv4-only |
| | | 20 | IPv4-only |
| | | 22 | IPv6/IPv4 |
| | | 26 | IPv6-only |
| | | 30 | IPv6-only |
| 36 | IPv6-only | 22 | IPv6/IPv4 |
| | | 26 | IPv6-only |
| | | 30 | IPv6-only |

With reference to Table (I), it is shown that the IPv4-only client 14 can contact either IPv4-only or IPV6/IPv4 servers 19, 20 and 22 but not servers 26 and 30 that are IPv6-only. The IPv6/IPv4 client 34 can contact all of the servers, i.e., servers 19, 20, 22, 26 and 30 and automatically adapt to either IPv4 or IPv6 as used by the corresponding server. The IPv6-only client 36 can contact either IPv6-only or IPv6/IPv4 servers 22, 26 and 30 but not servers 19 and 20 that are IPv4-only.

Using the illustrative heterogeneous IPv6/IPv4 network 300 of FIG. 3, the process of requesting server access from a client in the network will be described. It is noted that this process is considerably more complicated in the heterogeneous network 300 of FIG. 3 as compared with the homogeneous network 200 of FIG. 2. In the present illustrative example, an IPv6/IPv4 node, e.g., client 34, may attempt to contact any of the servers 19, 20, 22, 26 and 30 which are respectively, IPv4-only, IPv6/IPv4 and IPv6-only nodes in the network 300. As in the previous example, a first step for the contacting node, i.e., the IPv6/IPv4 client 34 in contacting a server in the network is, to first contact the vendor portal 18 to get a list of server's hostnames. Then, a user associated with client 34 may select one of the server's hostnames from the returned list whereby the client then makes a DNS request to map the selected server's hostname to a binary IP address to enable the client 34 to take up communication with the selected server.

Assuming that all DNS servers have been upgraded to support IPv6 records (i.e., A6 or AAAA records), the DNS service will return to the client 34:
(at least one) IPv4 address in the case where an IPv4-only server 19 or 20 was selected, or
(at least one) IPv6 (and IPv4) address in the case where IPv6/IPv4 server 22 was selected, (it is noted that one or two addresses may be returned dependent upon how server 22 was registered at the DNS server—either with a single IPv6 address according to the 6 to 4 scheme or with both an IPv4 as well as an IPv6 address.
(at least one) IPv6 address in the case where either IPv6-only server 26 or IPv6-only server 30 was selected.

Once an IP address is obtained from the DNS server, the client 34 can then initiate communication with:
IPv4-only server 19 or 20 using IPv4 packages;
IPv6/IPv4 server 22 using either IPv4 packages or IPv6 packages encapsulated into IPv4 ones, i.e. tunneling will be applied. In the latter case the begin point of the tunnel will be the IPv6/IPv4 client 34 while the end point of the tunnel will be the server 22, i.e. this will be host-to-host 6 to 4 automatic tunneling (ref. RFC 2893).
IPv6-only server 26 using IPv6 packages encapsulated into IPv4 ones, i.e. tunneling will be applied. In the latter case the begin point of the tunnel will be the client 34 while the end point of the tunnel will be the server 22 (that is a router for server 26), i.e. this will be host-to-router 6 to 4 automatic tunneling (ref. RFC 2893).
IPv6-only server 30 using IPv6 packages tunneled into IPv4 ones. The begin point of the tunnel will be the IPv6/IPv4 client 34 while the end point of the tunnel will be the IPv6/IPv4 relay router 28. In case the latter is 6 to 4 relay router it can be automatically detected by using the anycast prefix for 6 to 4 routers as defined in RFC 3068. This implies that the client 34 should be configured with default relay router prefix equal to 2002:c058:6301::/48. This prefix corresponds to the IPv4 address 192.88.99.1.

The addressing scheme described above for a heterogeneous network assumed that all DNS servers have been upgraded to support IPv6 records (i.e., A6 or AAAA records) in the migration from IPv4 to IPv6. However, this assumption may be unrealistic in that, in the migration from IPv4 to IPv6, it is quite likely that there will be “legacy” DNS servers supporting only IPv4 records, i.e. only A records. For example, in the illustrative network 300, if the primary and the secondary DNS servers for the IPv6-only server 26 or IPv6-only server 30 only supports IPv4 records and did not support A6 records, then the IPv6/IPv4 client 34 sending a DNS request for resolving the hostname of server 26 or 30 will fail and most likely be interrupted because of a time-out.

The present invention is directed to overcoming this ‘legacy’ problem of certain DNS servers only supporting IPv4 records. Specifically, the present invention discloses a method for allowing a requesting client located in a communication network system that only supports tunneling as a transition mechanism to set-up a communication with those server's whose hostnames are not resolvable via a DNS server because the DNS server is a legacy DNS server supporting only IPv4 records.

D. An Embodiment

Resolution of hostnames which are otherwise not resolvable via a DNS server for the reasons stated above and other reasons not explicitly recited herein, is obtainable in accordance with the embodiment of the invention. Broadly stated, resolution of the server hostname is achieved by the client with support from or cooperation with the vendor portal 18. The vendor portal 18 provides support by maintaining two novel tables—a first table referred to herein as a Server's hostname table and a second associated table, referred to herein as a Hostname2IPaddress table.

Exemplary structures of the Server's hostname table 50 and Hostname2IPaddress table 40 are shown in FIG. 4. These tables are preferably stored at portal 18. As shown in FIG. 4, Server's hostnames table 50 is composed of three columns. The first column, labeled “hostnames” 51, lists all of the server's hostnames known to the vendor portal 18. The second column, labeled “IP address version” 53, lists the IP version of the server's address, i.e. IPv4-only, or IPv6/IPv4 or IPv6-only. The third column, labeled “IP address obtainable via DNS server” 55, lists whether or not the corresponding server's IP address is resolvable via a DNS server (e.g., yes/no). It is contemplated that each server can provide an entry in the table 50 when it registers at the vendor portal 18. The information can be made mandatory for registration purposes. In the case where a server is not reachable by a DNS (for whatever reasons) it should specify at least one valid IP address to the vendor portal 18 as a guarantee for its accessibility. This information is maintained in a second table of the invention, referred to as a Hostname2IPaddress table 40, as shown in FIG. 4. Hostname2IPaddress table 40 is composed of a three columns. The first column, labeled “hostnames” 41, lists the hostnames of those servers from the Server's hostnames table 50 whose hostnames are not resolvable into an IP address via a DNS. In the illustrative example, this would include server 26 and server X. The second column of table 40, labeled “IP address” 43, lists at least one valid IP address as a guarantee for the server's accessibility. The third column of the Hostname2IPaddress table 40, labeled “Relay Router” 45, indicates the identity of a Relay Router (if applicable). If a server with a native IPv6 address is aware of some specific relay routers address then the server should specify it to the vendor portal 18 and this information will be stored in the column 45 of table 40.

If a given host has a 6 to 4 address then it can exchange packets with another host using 6 to 4 anywhere on the Internet and therefore no relay router information is needed. For example, client 34 or 36 can communicate with server 22 or 26 without any relay routers. However, communicating with an IPv6-only node possessing a native global IPv6 address that is not 6 to 4 compatible requires a 6 to 4 Relay Router (see ref. RFC 2373, 2374). The relay router is configured to support transit routing between a 6 to 4 address and native IPv6 addresses. In FIG. 3 client 34 or 36 can communicate with server 30 only via relay router 28.

An interaction between a client (e.g., one of the clients 14, 34, or 36) and the vendor portal 18 proceeds in accordance with the following rules:

When an initial connection is established between the client and the portal 18, the client obtains the Server's hostname table 50 from the vendor portal 18. The client knows its own IP version (e.g., IPv6-only for client 36) and therefore internally filters the servers listed in the first column 51 of the table 50 provided by the portal 18 to retain only those servers it has determined it can communicate with. Filtering the server hostnames listed in column 51 of the table 50 is based on the information provided in the second column 53 of table 50. In the instant example, IPv6-only client 36 filters the list of six hostnames in column 51 of table 50 to exclude two hostnames and retain four hostnames from the list, namely, the IPv6-only servers 26, 30, X, and the IPv6/IPv4 server 22. Servers 19 and 20 were excluded based on the determination that IPv6-only client 36 cannot establish communication with IPv4-only servers.

At a next step, the client 36 presents the filtered list of server's hostnames to the associated user via a standard user interface. The associated user may then select one of the server's hostnames from the filtered list. If the IP address of the selected server is obtainable via a DNS server (i.e. a ‘yes’ indicator in the third column 55 of table 50) then the client 36 proceeds with a DNS request to resolve the server hostname as is conventional. Otherwise, if the selected server's IP address is not obtainable via a DNS server (i.e., a ‘no’ indicator), then the client executes a special protocol, referred to herein as the “HelpMeToGetIPaddress(hostname)” protocol, with the portal 18. In the instant example, if the client 36 chose server 22 from the filtered list, its IP address would be obtainable via a DNS server. Alternatively, if the client 36 chose server 26 from the filtered list, its IP address would not be obtainable via a DNS server and the protocol must be invoked in this instance. The protocol involves the use of associated table 40. More particularly, the protocol involves portal 18 performing a look up in the first column 41 of table 40, using the hostname of the selected server (e.g., server 26) as a search key or index, to determine the servers one or more IP addresses stored in the second column 43 of each record of table 40. If applicable, the corresponding relay router is determined from the third column 45 of table 40.

FIG. 5 is a flowchart illustrating an algorithm for allowing a client to access a requested server in a heterogeneous IPv6/IPv4 network, where the server's IP address may or may not be resolvable by a DNS service. Continued reference is made to the IPv6/IPv4 network 300 in FIG. 3. In the description, the client refers to any one the clients 14, 34 or 36 of the network in FIG. 3. The portal refers to vendor portal 18 in FIG. 3 and tables 50 and 40 are supported by the vendor portal 18.

At step 52, the client obtains the Server's hostnames table 50 from the portal 18 and filters the provided list of servers stored in the first column 51 of table 50. The filtering is performed by comparing the IP version(s) used by the client and the IP version(s) used by the respective servers in the list. Specifically, for each entry (record) of the table 50, the client IP version is compared against the server IP version (as defined in the second column 53, i.e., “IP address version”) of table 50. If it is determined that the IP versions are such that communication is capable between client and server, the server is retained in the filtered list, otherwise the server is excluded. The client then presents the filtered list of server's hostnames to an associated user of the client via a user interface.

At step 54, the user associated with the client may select one server hostname from the displayed filtered list.

At step 56, the client then checks, via the third column 55 of table 50, whether the IP address of the selected server is obtainable via a DNS server. If “YES”, the algorithm proceeds to step 60, otherwise the algorithm proceeds to step 70.

At step 60, the client requests its default DNS server to return the IP address of the selected server's hostname and the algorithm proceeds to step 62.

At step 62, the client gets the selected servers' one or more IP addresses. It is noted that, if the server has been registered with more that one IP address (e.g. two IPv4 addresses or an IPv4 and an IPv6 address) the DNS server will return all of them. The algorithm then proceeds to step 80.

At step 70, the client executes the “HelpMeToGetIPaddress(hostname)” protocol with the portal 18 as explained above to obtain the server's default IP address(es) and any associated router information.

At step 72, the client gets the server's IP address(es) and the corresponding relay router (if applicable) as an output of the “HelpMeToGetIPaddress(hostname)” protocol invoked at step 70. The algorithm then proceeds to step 80.

At step 80, the client checks whether (the first of) the returned address(es) as an output of either a DNS request or the “HelpMeToGetIPaddress(hostname)” protocol is the same IP version as its own address. If “yes”, the algorithm proceeds to step 82, otherwise the algorithm proceeds to step 84.

At step 82, the client checks whether the IP addresses are IPv6 addresses. If “yes” the algorithm proceeds to step 100, otherwise the algorithm proceeds to step 90.

At step 84, the client selects the next address returned by either the DNS or the “HelpMeToGetIPaddress(hostname)” protocol and returns to step 80. It is noted that due to the filtering of servers performed at step 52 there will be at least one server's IP address the client can use to communicate.

At step 90, the client communicates with the server using IPv4.

At step 100, the client checks whether the client's and server's IPv6 addresses are composed according to 6 to 4 scheme (ref. RFC 3056), i.e. the first 16 bits of the prefix are equal to 2002. In case “Yes” the algorithm proceeds to step 102, otherwise the algorithm proceeds to step 104.

At step 102, the client communicates with the server using IPv6 and 6 to 4 automatic tunneling (ref. RFC 2893).

At step 104, the client communicates with the server using IPv6 and automatic tunneling (ref. RFC 2893) as the end point of the tunnel is always a relay router. If the relay router is 6 to 4 it can be automatically detected by using the anycast prefix 2002:c058:6301::/48 for 6 to 4 routers as defined in RFC 3068. If the relay router is not 6 to 4 and the client has executed step 72 the relay router's address/prefix will be retrieved from table 40 by the portal 18 and returned to the client as an output of executing the “HelpMeToGetIPaddress(hostname)” protocol.

Finally, the above-discussion is intended to be merely illustrative of the present invention and should not be construed as limiting the appended claims to any particular embodiment or group of embodiments. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) each of the disclosed elements may be comprised of hardware portions (e.g., discrete electronic circuitry), software portions (e.g., computer programming), or any combination thereof.

1. A method for establishing communication between a client node (14, 34, 36) and a server node in a heterogeneous IP network (300), said method comprising the steps of:
(a) making a request, by a user associated with said client, to a portal (18) in said network (300) for a list of server hostnames (51) capable of providing a desired content to said client;
(b) providing a first table (50) and a second table (40) from said portal (18) to said client responsive to said client request, said first table (50) including said list of server node hostnames (51);
(c) filtering at said client (14,34,36), said provided list of server hostnames (51) to exclude those server hostnames (51) with whom said client (14,34,36) cannot establish a communication;
(d) selecting by said user, a server hostname (51) from said filtered list of server hostnames (51);
(e) determining from said first table (50) if an IP address associated with said user selected server hostname (51) is resolvable via a domain name server (DNS);
(f) if said step (e) is satisfied, obtaining said associated IP address from said DNS; and
(g) if said step (e) is not satisfied, executing a protocol by said client (14,34,36) with said portal (18) to determine one or more default IP addresses of a server having said selected server's hostname (51).

2. The method of claim 1, further including the step of establishing a communication with said selected server (19,20,22,26,30) using said associated IP address, following said step (f).

3. The method of claim 2, wherein the step of establishing a communication
with said selected server (19,20,22,26,30) further comprises the steps of:
(1) determining if an IP version of a first returned IP address from said DNS is the same version as an IP version of said client (14,34,36);
(2) if said step (1) is not satisfied, obtaining a next returned IP address from said DNS and repeating said step (1);
(3) if said step (1) is satisfied, determining if said IP version of said first returned IP address and said IP version of said client (14,34,36) are IPv6 versions;
(4) if said step (3) is satisfied, determining if said IPv6 versions are 6 to 4 addresses; and
(5) if said step (4) is satisfied, establishing a communication with said selected server (19,20,22,26,30) using said IPv6 protocol and automatic tunneling.

4. The method of claim 3, wherein if said step (4) is not satisfied, establishing a communication with said selected server (19,20,22,26,30) using an IPv6 protocol and a tunneling method having a relay router as an endpoint address.

5. The method of claim 3, wherein if said step (3) is not satisfied, establishing a communication with said selected server (19,20,22,26,30) using an IPv4 protocol.

6. The method of claim 1, further including the step of establishing a communication with said selected server (19,20,22,26,30) using said associated IP address, following said step (g).

7. The method of claim 6, wherein the step of establishing a communication with said selected server (19,20,22,26,30) further comprises the steps of:
(1) determining if an IP version of a first returned IP address from said second table (40) is the same version as an IP version of said client (14,34,36);
(2) if said step (1) is not satisfied, obtaining a next returned IP address from said second table (40) and repeating said step (1);
(3) if said step (1) is satisfied, determining if said IP version of said first returned IP address and said IP version of said client (14,34,36) are IPv6 versions;
(4) if said step (3) is satisfied, determining if said IPv6 versions are 6 to 4 addresses; and
(5) if said step (4) is satisfied, establishing a communication with said selected server (19,20,22,26,30) using said IPv6 protocol and automatic tunneling.

8. The method of claim 7, wherein if said step (4) is not satisfied, establishing a communication with said selected server (19,20,22,26,30) using an IPv6 protocol and a tunneling to a relay router address obtained from said second table (40) as an endpoint address.

9. The method of claim 7, wherein if said step (3) is not satisfied, establishing a communication with said selected server (19,20,22,26,30) using an IPv4 protocol.

10. The method of claim 1, wherein said determining step further comprises performing a lookup in said first table (50) by said client (14,34,36) using said user selected server hostname (51) as an index, to obtain a record value indicating the resolvability status of the selected server's hostname (51) via said DNS.

11. The method of claim 1, wherein said step (g) further comprises performing by said client (14,34,36), a lookup in said second table (40) using said user selected server's hostname (51) as an index, to determine one or more default IP addresses (43) associated with said user selected server's hostname (51) for establishing a communication with said selected server (19,20,22,26,30).

12. The method of claim 1, further including, prior to said step (a), the step of populating said first table (50) at said vendor portal (18) with a plurality of records, each of the records comprising:
said server hostname (51) of a server in said network (300) capable of providing said desired content to said client (14,34,36);
an IP address version (53) associated with said server hostname (51); and
an indicator (55) of whether said server hostname (51) is resolvable via a DNS server in said network (300).

13. The method of claim 8, wherein said populating step is performed during a registration stage prior to the operation of said IP network (300).

14. The method of claim 1, further including, prior to said step (a), the step of populating said second table (40) at said vendor portal (18) with a plurality of records, each of the records comprising:
said server hostname (41) of a server in said network (300) capable of providing said desired content to said client (14,34,36);
a default IP address (43) associated with said server hostname (41); and a relay router address (45).

15. The method of claim 14, wherein said populating step is performed during a registration stage prior to the operation of said IP network (300).

16. The method of claim 1, wherein said step (c) further comprises the steps of:
comparing an IP address version of said client (14,34,36) with one or more IP address versions (53) associated with said server hostname (51) to determine from said comparison if said compared IP address versions are capable of establishing a communication between said client (14,34,36) and said server;
if said comparison step is satisfied, retaining said server hostname (51) and associated record information in said filtered list; and
otherwise deleting said server hostname (51) and said associated information from said filtered list.

17. A system (300) for establishing communication between a client (14,34,36) node (14,34,36) and a server node (19,20,22,26,30) in an heterogeneous IP network (300), said system comprising:
means for making a request, by a user associated with said client (14,34,36), to a portal (18) in said network (300) for a list of server hostnames capable of providing a desired content to said client (14,34,36);
means for providing a first table (50) and a second table (40) from said portal (18) to said client (14,34,36) responsive to said client request, said first table (50) including said list of server node hostnames (51);
means for filtering at said client (14,34,36), said provided list of server hostnames (51) to exclude those server hostnames (51) with whom said client (14,34,36) cannot establish a communication;
means for selecting by said user, a server hostname (51) from said filtered list of server hostnames;
means for determining from said first table (50) if an IP address associated with said user selected server's hostname (51) is resolvable via a domain name server (DNS);
means for obtaining said associated IP address from said DNS if said means for determining is satisfied; and
means for executing a protocol by said client (14,34,36) with said portal (18) to determine one or more default IP addresses (43) of a server (19,20,22,26,30) having said selected server hostname (51) if said means for determining is not satisfied.

18. The system (300) of claim 17, further comprising means for establishing a communication with said selected server (19,20,22,26,30) using said associated IP address when said means for determining is satisfied.

19. The system (300) of claim 18, wherein said means for establishing a communication with said selected server (19,20,22,26,30) using said associated IP address further comprises:
first means for determining if an IP version of a first returned IP address from said DNS is the same version as an IP version of said client (14,34,36);
means for obtaining a next returned IP address from said DNS and repeating determining means if said determining means is not satisfied; second means for determining if said IP version of said first returned IP address and said IP version of said client (14,34,36) are IPv6 versions if said first determining means is satisfied;
third means for determining if said IPv6 versions are 6 to 4 addresses if said means for determining if said second determining means is satisfied; and
means for establishing a communication with said selected server (19,20,22,26,30) using said IPv6 protocol and automatic tunneling if said third means is satisfied.

20. The system (300) of claim 19, wherein if said third means for determining is not satisfied establishing a communication with said selected server (19,20,22,26,30) using an IPv6 protocol and a tunneling method having a relay router as an endpoint address.

21. The system (300) of claim 19, wherein if said second means for determining is not satisfied establishing a communication with said selected server (19,20,22,26,30) using an IPv4 protocol.

22. The system (300) of claim 17, further comprising means for establishing a communication with said selected server (19,20,22,26,30) using said associated IP address when said means for determining is not satisfied.

23. The system (300) of claim 22, wherein said means for establishing a communication further comprises:
first means for determining if an IP version of a first returned IP address from said second table (40) is the same version as an IP version of said client (14,34,36); means for obtaining a next returned IP address from said second table (40) and repeating said first means for determining if said first means for determining is not satisfied; second means for determining if said IP version of said first returned IP address and said IP version of said client (14,34,36) are IPv6 versions if said first means for determining is satisfied; third means for determining if said IPv6 versions are 6 to 4 addresses if said second means for determining is satisfied;
and means for establishing a communication with said selected server (19,20,22,26,30) using said IPv6 protocol and automatic tunneling if said third means for determining is satisfied.

24. The system (300) of claim 23, wherein if said third means for determining is not satisfied establishing a communication with said selected server (19,20,22,26,30) using an IPv6 protocol and a tunneling method having a relay router as an endpoint address.

25. The system (300) of claim 26, wherein if said second means for determining is not satisfied establishing a communication with said selected server (19,20,22,26,30) using an IPv4 protocol.

26. The system (300) of claim 17, wherein said first table (50) is resident at said vendor portal (18) and is comprised of a plurality of records, each of the records further comprising:
said server hostname (51) of a server in said network (300) capable of providing said desired content to said client (14,34,36);
an IP address version associated with said server hostname (51); and an indicator of whether said server hostname (51) is resolvable via a DNS server in said network (300).

27. The system (300) of claim 17, wherein said second table (40) is resident at said vendor portal (18) and is comprised of a plurality of records, each of the records further comprising:
said server hostname (41) of a server in said network (300) capable of providing said desired content to said client (14,34,36);
a default IP address (43) associated with said server hostname (41); and a relay router address (45).
